(19) United States
(12) Patent Application Publication
(10) Pub. No.: US 2016/0259201 A1
(43) Pub. Date: Sep. 8, 2016

(54) LIQUID CRYSTAL DEVICE, THE BORDER AND THE LIQUID CRYSTAL PANEL THEREOF

(71) Applicant: SHENZHEN CHINA STAR OPTOELECTRONICS TECHNOLOGY CO., LTD., Shenzhen (CN)

(72) Inventor: Chengwen QUE, Shenzhen (CN)

(73) Assignee: Shenzhen China Star Optoelectronics Technology Co., Ltd., Shenzhen (CN)

(21) Appl. No.: 14/437,819

(22) PCT Filed: Oct. 31, 2014
(86) PCT No.: PCT/CN2014/090019

§ 371 Date: Apr. 22, 2015

(30) Foreign Application Priority Data
Oct. 22, 2014 (CN) 201410567956.X

(51) Int. Cl. G02F 1/1333

(52) U.S. Cl. CPC G02F 1/133308; G02F 2001/133314; G02F 2001/133354

(57) ABSTRACT

A liquid crystal device including a liquid crystal panel and a border is disclosed. The border includes a sidewall, a packing member bent to extent from a top of the sidewall, a carrying member vertically connected with the sidewall, and the carrying member is parallel to the packing member to form a gap. The liquid crystal panel includes a CF substrate and a TFT substrate, and a dimension of the TFT substrate is larger than the dimension of the CF substrate. The TFT substrate is arranged opposite to the CF substrate, and ends of the TFT substrate and the CF substrate form a stair. The stair is inserted into the gap to align a surface of the liquid crystal panel with the surface of the packing member. In this way, the structure of the LCD is simplified.

### BACKGROUND OF THE INVENTION

1. Field of the Invention

The present disclosure relates to liquid crystal display technology, and more particularly to a border and a liquid crystal panel and the liquid crystal device (LCD) with the same.

2. Discussion of the Related Art

With the growing competition of the display devices, it is more important to come out differentiated design for the products. For instance, super thin/narrow border is one of the developed differentiated design. As shown in FIG. 1, the super thin/narrow border LCD 10 includes a front frame 1, a liquid crystal panel 2, a plurality of optical components 4, and a back housing 5. The front frame 1 includes a pressing member 6 for pressing the liquid crystal panel 2 via buffering components so as to shield a terminal area 7 of the liquid crystal panel and to fix the liquid crystal panel 2. The front frame 1 further includes a lateral surface 8. The front frame 1 is fixed by engaging screws on the lateral surface 8 of the front frame 1. As the above-mentioned demand, the pressing member 6 may increase the thickness (H) of the liquid crystal panel 2, and the lateral surface 8 may increase the thickness (D), which limit the super thin/narrow design.

### SUMMARY

In one aspect, a liquid crystal device (LCD) includes: a liquid crystal panel and a border, the border includes a sidewall, a packing member bent to extent from a top of the sidewall, a carrying member vertically connected with the sidewall, and the carrying member is parallel to the packing member to form a gap; the liquid crystal panel includes a CF substrate and a TFT substrate, a dimension of the TFT substrate is larger than the dimension of the CF substrate, the TFT substrate is arranged opposite to the CF substrate, and ends of the TFT substrate and the CF substrate form a stair; and wherein the stair is inserted into the gap to align a surface of the liquid crystal panel with the surface of the packing member.

Wherein ends of the TFT substrate includes a plurality of clasping members, reversing slopes are formed at two ends of the clasping member, and wherein a clasping slot having a shell nosing is formed between two adjacent clasping members.

Wherein the border further includes clasping elastic sheets arranged within the gap, the clasping elastic sheet includes: a first slope, and a second slope respectively extending from the sidewall into the gap, and the first slope and the second slope cooperatively define a clasping slot for engaging with the clasping member; and guiding members respectively formed at two ends of the first slope and the second slope such that the clasping member slides into the clasping slot or the clasping member abuts against the reversing slope and slides into the clasping slot.

Wherein the LCD further includes a back housing having a bottom plate and a supporting member bent to extend from the bottom plate, and the bottom plate, the supporting member, and the comparing component cooperatively define a receiving space.

Wherein the LCD further includes at least one optical component to be arranged within the receiving space.

Wherein the border further includes a fixing member extending from the carrying member along a vertical direction, and the fixing member is parallel to the sidewall and forms a slot to be clasped by the supporting member.

Wherein the packing member includes a guiding slope for controlling a direction of excessive glue of the TFT substrate when the carrying member engages with the packing member.

Wherein two ends of the sidewall respectively comprise vertically extended side plates, and the side plates, the packing member, and the carrying member are vertically connected.

In another aspect, a border includes: a sidewall; a packing member bent to extent from an end of the sidewall; a carrying member vertically connected with the sidewall, and the carrying member is parallel to the packing member to form a gap; at least one clasping elastic sheet includes a first slope, and a second slope respectively extending from the sidewall into the gap, and the first slope and the second slope cooperatively define a clasping slot; and guiding members respectively formed at two ends of the first slope and the second slope such that the clasping member slides into the clasping slot.

In another aspect, a liquid crystal panel includes: a CF substrate; a TFT substrate, a dimension of the TFT substrate is larger than the dimension of the CF substrate, the TFT substrate is arranged opposite to the CF substrate, and ends of the TFT substrate and the CF substrate form a stair; and ends of the TFT substrate includes a plurality of clasping members, reversing slopes are formed at two ends of the clasping member, and wherein a clasping slot having a shell nosing is formed between two adjacent clasping members.

In view of the above, the stairs formed by the CF substrate and the TFT substrate is inserted to the gap formed by the packing member and the carrying member such that the surface of the liquid crystal panel align with the surface of the packing member. In this way, the structure of the LCD is simplified. The materials needed for manufacturing the LCD is reduced, and so does the cost. Also, the super thin/narrow design of the LCD can be achieved.

### BRIEF DESCRIPTION OF THE DRAWINGS

FIG. 1 is a cross section view of one conventional LCD.

FIG. 2 is a partial cross section view of the LCD in accordance with one embodiment.

FIG. 3 is a partial stereo view of the TFT substrate of FIG. 2.

FIG. 4 is a partial stereo view of the border of FIG. 2.

FIG. 5 is a partial cross section view of the LCD in accordance with another embodiment.

FIG. 6 is a partial cross section view of the LCD in accordance with another embodiment.

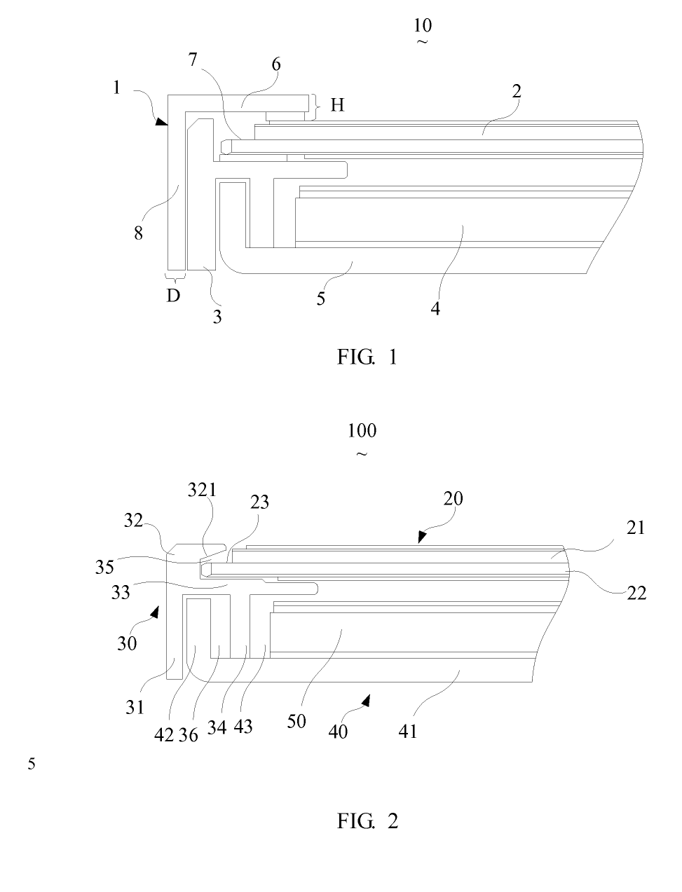

### DETAILED DESCRIPTION OF THE EMBODIMENTS

Embodiments of the invention will now be described more fully hereinafter with reference to the accompanying drawings, in which embodiments of the invention are shown.

FIG. 2 is a partial cross section view of the LCD in accordance with one embodiment. The LCD 100 includes a liquid crystal panel 20, a border 30, a back housing 40, and at least one optical component 50.

The border 30 includes a sidewall 31, a packing member 32, a carrying member 33, and a fixing member 34. The packing member 32 bent to extent from a top of the sidewall 31. The carrying member 33 and the sidewall 31 are vertically connected. The carrying member 33 is parallel to the packing member 32 to form a gap 35. The packing member 32 includes a guiding slope 321. The fixing member 34 extents from the carrying member 33 along a vertical direction. The fixing member 34 is parallel to the sidewall 31 to form a slot 36.

The liquid crystal panel 20 includes a CF substrate 21 and a TFT substrate 22. The dimension of the TFT substrate 22 is larger than the dimension of the CF substrate 21. The TFT substrate 22 is arranged opposite to the CF substrate 21. Ends of the TFT substrate 22 and the CF substrate 21 form a stair 23. The stair 23 is inserted into the gap 35 such that a surface of the liquid crystal panel 20 aligns with the surface of the packing member 32. The end of the TFT substrate 22 includes a glue area. When the carrying member 33 engages with the packing member 32, the guiding slope 321 is configured for controlling a direction of the excessive glue on the glue area. Specifically, the glue flows toward the gap 35 along the guiding slope 321. The back housing 40 includes a bottom plate 41, and a supporting member 42 bent to extend from the bottom plate 41. The bottom plate 41, the supporting member 42, and the comparing component 43 cooperatively define a receiving space 43 for receiving the optical component 50. The supporting member 42 is engaged within the slot 36 to prevent the members from being loosened. As such, the structure of the LCD 100 is stable. In other embodiments, the fixing member 34 may be omitted, and the supporting member 42 is for carrying the carrying member 33.

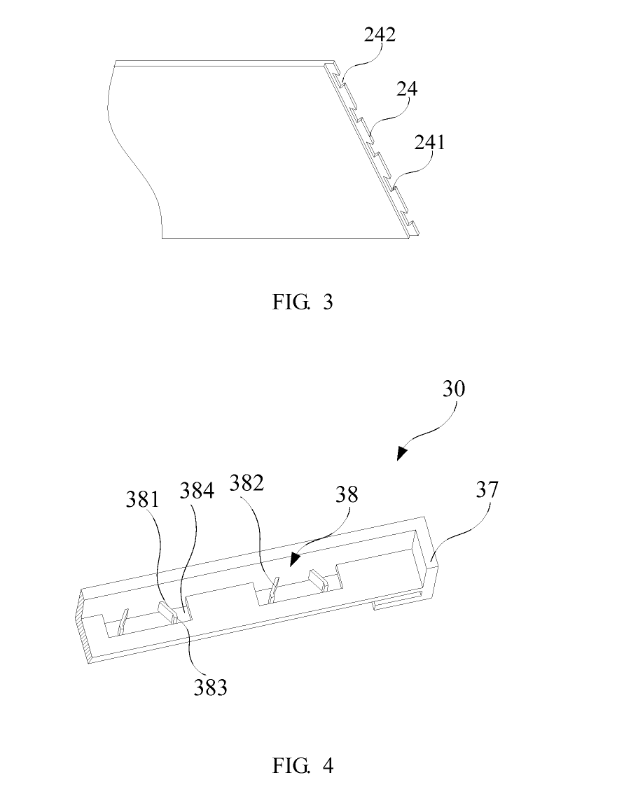

FIG. 3 is a partial stereo view of the TFT substrate of FIG. 2. The TFT substrate 22 includes a plurality of clasping members 24 arranged at its ends. Reversing slopes 241 are formed at two ends of the clasping member 24. A clasping slot 242 having a shell nosing is formed between two adjacent clasping members 24.

FIG. 4 is a partial stereo view of the border of FIG. 2. The border 30 further includes a side plate 37 and clasping elastic sheets 38 arranged within the gap 35.

Two ends of the sidewall 31 include the side plates 37 vertically connected. In addition, the side plate 37, the packing member 32, and the carrying member 33 are vertically connected. The clasping elastic sheets 38 includes a first slope 381, a second slope 382, and a guiding member 383. The first slope 381 and the second slope 382 respectively extend from the sidewall 31 into the gap 35. In addition, the first slope 381 and the second slope 382 cooperatively define a clasping slot 384 for engaging with the clasping member 24. Ends of the first slope 381, the second slope 382 respectively form a guiding member 383 such that the clasping member 24 slides into the clasping slot 384 or the clasping member 24 abuts against the reversing slope 241 and then slides into the clasping slot 242.

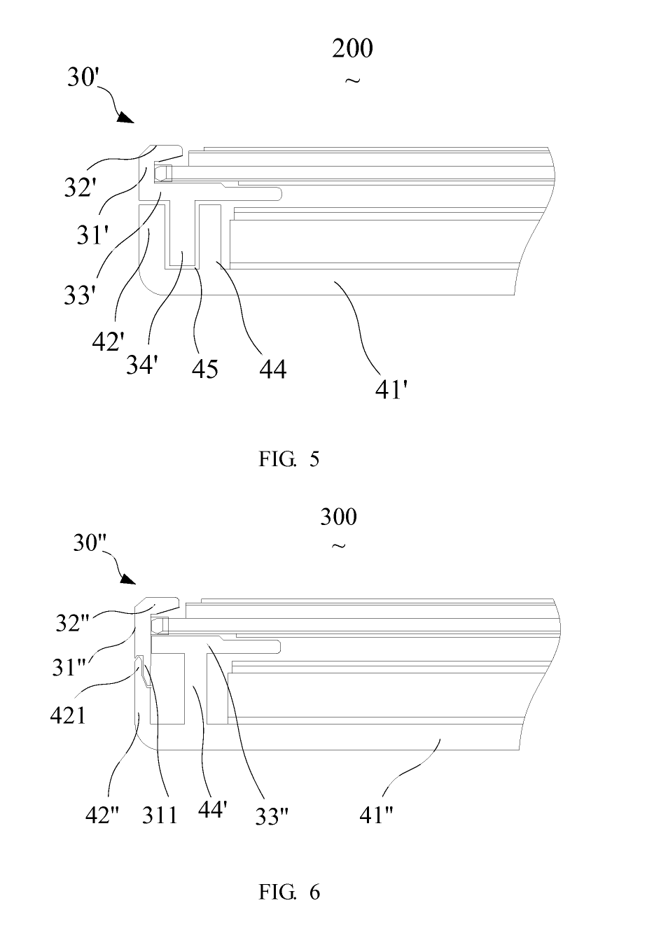

FIG. 5 is a partial cross section view of the LCD in accordance with another embodiment. The structure of the LCD 200 of this embodiment is similar to that of the LCD 100 in the first embodiment. The difference between the LCD 100 and the LCD 200 will be described hereinafter. In this embodiment, the bottom plate 41′ of the liquid crystal panel 200 includes a second supporting member 44 bent and extended from the bottom plate 41′. The second supporting member 44 and the supporting member 42′ form a fixing slot 45. In addition, the sidewall 31′ is vertically arranged between the ends of the packing member 32′ and the carrying member 33′. The sidewall 31′ needs not to extend toward an outer surface of the carrying member 33′. The fixing member 34′ vertically extending from the carrying member 33′ is inserted within the fixing slot 45. The sidewall 31′, the carrying member 33′, and the fixing member 34′ may be respectively connected or may be integrally formed.

FIG. 6 is a partial cross section view of the LCD in accordance with another embodiment. The structure of the LCD 300 of this embodiment is similar to that of the LCD 200 in the above-mentioned embodiment. The difference between the LCD 200 and the liquid LCD 300 will be described hereinafter. The carrying member 33″ and the second supporting member 44″ are vertically connected. The carrying member 33″ abuts against the sidewall 31″. The end of the supporting member 42″ includes a stepping-up stair 421. The sidewall 31″ is arranged with a stepping-down stair 311 for engaging with the stepping-up stair 421. In the embodiment, the bottom plate 41″, the supporting member 42″, the second supporting member 44″, and the carrying member 33″ may be respectively connected or may be integrally formed. However, the sidewall 31″ and the carrying member 33″ have not to be integrally formed.

In view of the above, the stairs formed by the CF substrate and the TFT substrate is inserted to the gap formed by the packing member and the carrying member such that the surface of the liquid crystal panel align with the surface of the packing member. In this way, the structure of the LCD is simplified. The materials needed for manufacturing the LCD is reduced, and so does the cost. Also, the super thin/narrow design of the LCD can be achieved.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal device (LCD), comprising:
a liquid crystal panel and a border, the border comprises a sidewall, a packing member bent to extent from a top of the sidewall, a carrying member vertically connected with the sidewall, and the carrying member is parallel to the packing member to form a gap;
the liquid crystal panel comprises a CF substrate and a TFT substrate, a dimension of the TFT substrate is larger than the dimension of the CF substrate, the TFT substrate is arranged opposite to the CF substrate, and ends of the TFT substrate and the CF substrate form a stair; and
wherein the stair is inserted into the gap to align a surface of the liquid crystal panel with the surface of the packing member.

2. The LCD as claimed in claim 1, wherein ends of the TFT substrate comprises a plurality of clasping members, reversing slopes are formed at two ends of the clasping member, and wherein a clasping slot having a shell nosing is formed between two adjacent clasping members.

3. The LCD as claimed in claim 2, wherein the border further comprises clasping elastic sheets arranged within the gap, the clasping elastic sheet comprises:
a first slope, and a second slope respectively extending from the sidewall into the gap, and the first slope and the second slope cooperatively define a clasping slot for engaging with the clasping member; and
guiding members respectively formed at two ends of the first slope and the second slope such that the clasping member slides into the clasping slot or the clasping member abuts against the reversing slope and slides into the clasping slot.

4. The LCD as claimed in claim 1, wherein the LCD further comprises a back housing having a bottom plate and a supporting member bent to extend from the bottom plate, and the bottom plate, the supporting member, and the comparing component cooperatively define a receiving space.

5. The LCD as claimed in claim 4, wherein the LCD further comprises at least one optical component to be arranged within the receiving space.

6. The LCD as claimed in claim 5, wherein the border further comprises a fixing member extending from the carrying member along a vertical direction, and the fixing member is parallel to the sidewall and forms a slot to be clasped by the supporting member.

7. The LCD as claimed in claim 1, wherein the packing member comprises a guiding slope for controlling a direction of excessive glue of the TFT substrate when the carrying member engages with the packing member.

8. The LCD as claimed in claim 1, wherein two ends of the sidewall respectively comprise vertically extended side plates, and the side plates, the packing member, and the carrying member are vertically connected.

9. A border, comprising:
a sidewall;
a packing member bent to extent from an end of the sidewall;
a carrying member vertically connected with the sidewall, and the carrying member is parallel to the packing member to form a gap;
at least one clasping elastic sheet comprises a first slope, and a second slope respectively extending from the sidewall into the gap, and the first slope and the second slope cooperatively define a clasping slot; and
guiding members respectively formed at two ends of the first slope and the second slope such that the clasping member slides into the clasping slot.

10. A liquid crystal panel, comprising:
a CF substrate;
a TFT substrate, a dimension of the TFT substrate is larger than the dimension of the CF substrate, the TFT substrate is arranged opposite to the CF substrate, and ends of the TFT substrate and the CF substrate form a stair; and
ends of the TFT substrate comprises a plurality of clasping members, reversing slopes are formed at two ends of the clasping member, and wherein a clasping slot having a shell nosing is formed between two adjacent clasping members.
